(19) United States
(12) Patent Application Publication
(10) Pub. No.: US 2026/0184331 A1
(43) Pub. Date: Jul. 2, 2026

(54) CONTROL DEVICE, CONTROL METHOD, NON-TRANSITORY COMPUTER READABLE STORAGE MEDIUM STORING COMPUTER PROGRAM

(71) Applicant: DENSO CORPORATION, Kariya-city (JP)

(72) Inventors: Yoshinori TAKEUCHI, Kariya-city (JP); Teiyu KIMURA, Kariya-city (JP); Hiroyuki OHSAWA, Kariya-city (JP); Kazuki IZUMI, Kariya-city (JP)

(21) Appl. No.: 19/549,355

(22) Filed: Feb. 25, 2026

Related U.S. Application Data
(63) Continuation of application No. PCT/JP2024/030274, filed on Aug. 26, 2024.

(30) Foreign Application Priority Data
Aug. 30, 2023 (JP) 2023-140467

(51) Int. Cl. B60W 50/14; B60K 35/28; B60W 50/00; B60W 50/02; B60W 60/00; B62D 15/02

(52) U.S. Cl. CPC B60W 50/14; B60K 35/28; B60W 50/0097; B60W 50/0205; B60W 60/001; B62D 15/021; B60K 2360/171; B60K 2360/1868; B60K 2360/195; B60W 2050/0215; B60W 2050/143; B60W 2050/146; B60W 2520/06; B60W 2520/10; B60W 2540/18

(57) ABSTRACT

A control device includes a processor configured to acquire turning angle information related to a turning angle of a tire under a turning control of the tire, and present steering-related information related to a virtual steering control that corresponds to the turning control of the tire. The steering-related information includes a steering-related image including a steering object. The processor is configured to present the steering-related information by displaying the steering object to rotate at a rotation angle corresponding to the turning angle during the autonomous driving on a display system, and change a display mode of the steering-related image including the steering object according to a control state of the vehicle.

### CROSS REFERENCE TO RELATED APPLICATIONS

The present application is a continuation application of International Patent Application No. PCT/JP 2024/030274 filed on Aug. 26, 2024, which designated the U.S. and claims the benefit of priority from Japanese Patent Application No. 2023-140467 filed on Aug. 30, 2023. The entire disclosures of all the above applications are incorporated herein by reference.

### TECHNICAL FIELD

The present disclosure relates to control technology for controlling a steering of a vehicle configured to perform autonomous driving.

### BACKGROUND ART

There is a steering angle display device for a vehicle that is arranged on a ring portion of a steering wheel and includes a display unit disposed along the ring portion.

### SUMMARY

A control device having a processor, which controls information presentation in a vehicle configured to perform an autonomous driving, is provided. The processor may be configured to acquire turning angle information related to a turning angle of a tire of the vehicle under a turning control of the tire during the autonomous driving, and present steering-related information related to a virtual steering control that corresponds to the turning control of the tire. The steering-related information may include a steering-related image including a steering object that is an object of a virtual steering member. The processor may be configured to present the steering-related information by displaying the steering object to rotate at a rotation angle corresponding to the turning angle during the autonomous driving on a display system, and change a display mode of the steering-related image including the steering object according to a control state of the vehicle. The display system may be configured to display at least one of speed information of the vehicle or entertainment information.

### BRIEF DESCRIPTION OF DRAWINGS

FIG. 1 is a block diagram showing the overall configuration of a first embodiment.

FIG. 2 is a schematic diagram showing a vehicle interior of the first embodiment.

FIG. 3 is a block diagram showing the functional configuration of a control device according to the first embodiment.

FIG. 4 is a flowchart showing a control flow according to the first embodiment.

FIG. 5 is a diagram showing an example of a steering object according to the first embodiment.

FIG. 6 is a diagram showing the relationship between a rotation angle of the steering object and a turning angle according to the first embodiment.

FIG. 7 is a diagram showing an example of a steering-related image in an emergency stop scene according to the first embodiment.

FIG. 8 is a diagram showing an example of the steering-related image in the emergency stop scene according to the first embodiment.

FIG. 9 is a diagram showing an example of the steering-related image in the emergency stop scene according to the first embodiment.

FIG. 10 is a diagram showing an example of the steering-related image in a stop scene according to a second embodiment.

FIG. 11 is a diagram showing an example of the steering-related image in the stop scene according to the second embodiment.

FIG. 12 is a diagram showing an example of the steering-related image in the stop scene according to a third embodiment.

FIG. 13 is a schematic diagram showing a vehicle interior according to a fourth embodiment.

FIG. 14 is a block diagram showing the functional configuration of a control device according to the fourth embodiment.

FIG. 15 is a flowchart showing a control flow according to the fourth embodiment.

### DESCRIPTION OF EMBODIMENTS

To begin with, examples of relevant techniques will be described.

There is a steering angle display device for a vehicle. The steering angle display device is arranged on a ring portion of a steering wheel and includes a display unit disposed along the ring portion. The steering angle display device includes a control unit configured to, during an autonomous driving control where a steering angle is controlled according to road conditions without rotating the steering wheel, display the steering angle of the vehicle at a position on the display unit according to the controlled steering angle.

The steering angle display device displays the steering angle on the ring portion of the steering wheel during the autonomous driving control and ends the display when the autonomous driving control ends. However, this steering angle display device has room for improvement in terms of convenience regarding the display position of the steering angle and the display of the steering angle in accordance with the control status of the vehicle.

The present disclosure provides a control device that improves convenience. The present disclosure also provides a control method that improves convenience. The present disclosure also provides a non-transitory computer readable storage medium storing a control program that improves convenience.

A first aspect of the present disclosure provides a control device having a processor, which controls information presentation in a vehicle configured to perform an autonomous driving. The processor is configured to acquire turning angle information related to a turning angle of a tire of the vehicle under a turning control of the tire during the autonomous driving, and present steering-related information related to a virtual steering control that corresponds to the turning control of the tire. The steering-related information includes a steering-related image including a steering object that is an object of a virtual steering member. The processor is configured to present the steering-related information by displaying the steering object to rotate at a rotation angle corresponding to the turning angle during the autonomous driving on a display system, and change a display mode of the steering-related image including the steering object according to a control state of the vehicle. The display system is configured to display at least one of speed information of the vehicle or entertainment information.

A second aspect of the present disclosure is a control method, executed by a processor, for controlling information presentation in a vehicle that is configured to perform an autonomous driving. The method includes acquiring turning angle information related to a turning angle of a tire of the vehicle under a turning control of the tire during the autonomous driving, and presenting steering-related information related to a virtual steering control that corresponds to the turning control of the steering-related information including a steering-related image that includes a steering object that is an object of a virtual steering member. The presenting of the steering-related information includes displaying the steering object to rotate at a rotation angle corresponding to the turning angle during the autonomous driving on a display system configured to display at least one of speed information of the vehicle or entertainment information, and changing a display mode of the steering-related image including the steering object according to a control state of the vehicle.

A third aspect of the present disclosure is a non-transitory computer readable storage medium storing instructions for controlling information presentation in a vehicle that is configured to perform an autonomous driving. The instructions are configured to, when executed by a processor, cause the processor to acquire turning angle information related to a turning angle of a tire of the vehicle under a turning control of the tire during the autonomous driving, and presenting steering-related information related to a virtual steering control that corresponds to the turning control of the tire. The steering-related information includes a steering-related image that includes a steering object that is an object of a virtual steering member. The processor is configured to present the steering-related information by displaying the steering object to rotate at a rotation angle corresponding to the turning angle during the autonomous driving on a display system configured to display at least one of speed information of the vehicle or entertainment information, and change a display mode of the steering-related image including the steering object according to a control state of the vehicle.

According to these first to third aspects, a steering-related image that includes at least a steering object is displayed on a display system configured to display at least one of speed information of the vehicle or entertainment information, in a display mode corresponding to the vehicle control state. The steering object is an object of a virtual steering member rotationally displayed at a rotation angle correlated with the turning angle during the autonomous driving. As a result, the user can visually recognize the travelling direction of the vehicle from the steering object in a display mode corresponding to the control state by visually checking the display system configured to display at least one of the vehicle speed information or the entertainment information. Thus, convenience can be improved.

Hereinafter, several embodiments of the present disclosure will be described with reference to the drawings. In the following, corresponding components in each embodiment are denoted by the same reference numerals, and redundant descriptions may be omitted. Furthermore, in cases where only a part of the configuration is described in each embodiment, the configurations of other parts previously described in other embodiments may be applied to those parts. Furthermore, in addition to the combinations of configurations explicitly described in each embodiment, it is also possible to partially combine configurations from multiple embodiments even if such combinations are not explicitly mentioned, provided that there is no hindrance to the combination.

### First Embodiment

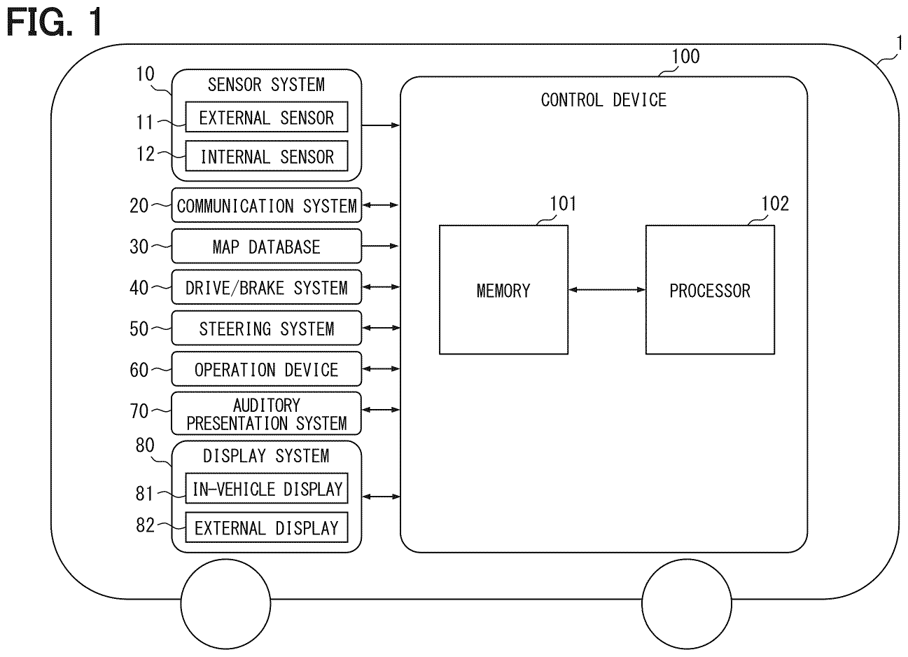

A control device 100 of a first embodiment shown in FIG. 1 is configured to control a display system 80 of a vehicle 1, which serves as a host mobile body. From the viewpoint centered on the vehicle 1, the vehicle 1 can also be referred to as an ego-vehicle. The vehicle 1 is a mobile body, such as an automobile, which is configured to travel on a roadway when a user, as an occupant, is on board.

The vehicle 1 is an autonomous robot provided with an autonomous driving mode, which is classified into levels according to the degree of manual intervention by the user in dynamic driving tasks. The autonomous driving mode may be achieved with an automated driving control, such as conditional driving automation, advanced driving automation, or full driving automation, where the system in operation performs all dynamic driving tasks. The autonomous driving mode may also be realized by advanced driver assistance control, such as driver assistance or partial driving automation, in which the user executes a portion of the dynamic driving tasks. The autonomous driving mode may be realized by either one or combination of the automated driving control and the advanced driving assistance control or switching between the automated driving control and the advanced driving assistance control. The vehicle 1 may also be referred to as an autonomous vehicle. The vehicle 1 may be applied to a system that provides a service in which the vehicle 1 is dispatched to a user who wishes to board and travels by autonomous driving to the user's destination.

In the autonomous driving mode, a medium-to long-term driving plan for determining a planned travel route from the current vehicle location to the destination, and a short-term control plan for traveling along the medium-to long-term driving plan, are sequentially generated either in the vehicle 1 or at an external center. Autonomous driving is achieved by executing driving control in the vehicle 1 in accordance with each plan.

The vehicle 1 includes a sensor system 10, a communication system 20, a map database 30, a drive/brake system 40, a steering system 50, an operation device 60, an auditory presentation system 70, and a display system 80, as shown in FIG. 1. The sensor system 10 acquires sensor information, which is to be used by the control device 100, by detecting an external environment and an internal environment of the vehicle. The sensor system 10 includes an external environment sensor 11 and an internal environment sensor 12.

The external environment sensor 11 is configured to acquire external environment information as sensor information from the surroundings of the vehicle 1, which constitute the external environment. The external environment sensor 11 may be of an object detection type configured to detect objects present in the external environment of the vehicle 1. The object detection type external environment sensor 11 may be at least one type selected from among an external camera, LiDAR (Light Detection and Ranging/Laser Imaging Detection and Ranging), radar, and sonar.

The internal environment sensor 12 is configured to acquire internal environment information as sensor information from the internal environment of the vehicle 1. The internal environment sensor 12 may be of a physical quantity detection type configured to detect specific physical quantities within the internal environment of the vehicle 1. The physical quantity detection type internal environment sensor 12 may include at least one type among a vehicle speed sensor, an acceleration sensor, a gyro sensor, and a turning angle sensor. The turning angle refers to the angle of tires 54 with respect to the longitudinal direction of the vehicle 1. The turning angle may also be referred to as the tire angle or the tire turning angle.

The internal environment sensor 12 may be of a user detection type configured to detect a specific state of the user within the internal environment of the vehicle 1. The user detection type internal environment sensor 12 is at least one type selected from an in-vehicle camera, a seat sensor, an actuator sensor, and an in-vehicle device sensor. The seat sensor is configured to detect the seating status of the user in each seat within the vehicle interior. The actuator sensor detects at least one type of user command status with respect to the driving actuators of the vehicle 1, such as the operation status of the accelerator pedal, the operation status of the brake pedal, the ON/OFF status of the start switch, and the shift status of the shift lever. The in-vehicle device sensor detects at least one type of user instruction status for in-vehicle devices, such as the operation status of the on/off switch, the operation status of the touch panel, and contactless recognizable gestures.

The communication system 20 is configured to acquire communication information usable by the control device 100 via wireless communication. The communication system 20 may be of a positioning type that receives positioning signals from GNSS (Global Navigation Satellite System) satellites existing outside the vehicle 1. The positioning-type communication system 20 may be a GNSS receiver. The communication system 20 may also be of a V2X type that transmits and receives communication signals with a V2X system existing outside the vehicle 1. The V2X-type communication system 20 may be at least one type selected from among DSRC (Dedicated Short Range Communications) device and cellular V2X (C-V2X) communication device. The communication system 20 may also be of a terminal communication type that transmits and receives communication signals with terminals existing inside the vehicle 1. The terminal communication-type communication system 20 may be at least one type selected from among Bluetooth (registered trademark) devices, Wi-Fi (registered trademark) devices, and infrared communication devices.

The map database 30 stores map information that can be utilized by the control device 100. The map database 30 includes at least one type of non-transitory tangible storage medium, such as a semiconductor memory, magnetic medium, or optical medium. The map database 30 may also serve as a database for a locator configured to estimate self-state quantities, including the self-position of the vehicle 1. The map database 30 may also serve as a database for a navigation unit that navigates the travel route of the vehicle 1. The map database 30 may be configured by a combination of two or more types among these databases.

The map database 30 acquires and stores the latest map information, for example, through communication with an external center via a V2X-type communication system 20. Here, the map information is digitized in two or three dimensions as information representing the driving environment of the vehicle 1. In particular, digital data of high-precision maps may be used as the three-dimensional map data. The map information may include road information representing at least one type among the position, shape, and surface condition of the road. The map information may include signage information representing at least one type among the position and shape of signs and lane markings associated with the road. The map information may include structure information representing at least one type among the position and shape of buildings and traffic signals facing the road.

The drive/brake system 40 includes a drive system composed of components for accelerating the vehicle 1, and a brake system composed of components for decelerating the vehicle 1. The components constituting the drive system include multiple types of components such as an accelerator pedal, a drive motor, a drive engine, a start switch, a transmission, and a shift unit. The components constituting the brake system include multiple types of components such as the tires 54, a battery, a brake pedal, a friction braking unit, a hydraulic circuit, and a regenerative motor.

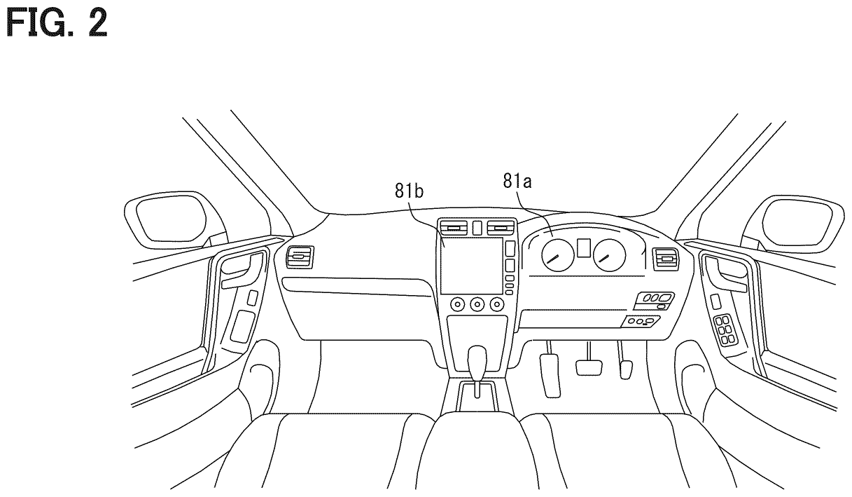

The steering system 50 shown in FIG. 2 is formed of components for providing steering to the vehicle 1. The components constituting the steering system 50 include multiple types of components such as an electric power steering device, a turning unit, and the tires 54. The turning unit turns the tires 54 at a turning angle that is sequentially specified by autonomous driving control. It should be noted that, in this embodiment, the steering system 50 of the vehicle 1, as shown in FIG. 2, does not include a steering member, such as a steering wheel, which is connected to the electric power steering device via a steering shaft.

The operation device 60 is an operation member configured to accept control operations for the vehicle 1 by the user. The operation device 60 is configured to allow at least steering operations to be input. The operation device 60 may further be configured to allow input of at least one type of operation among acceleration and deceleration operations. For example, the operation device 60 is a control pad, which is held by the user in a state where the control pad is not fixed to the vehicle 1 at least when accepting control operations. The control pad as the operation device 60 is provided with at least one type of input, such as push buttons, joysticks, or a directional pad. The control pad as the operation device 60 is connected to the control device 100 by at least one of wired or wireless methods. The control pad as the operation device 60 may be held in a holding section provided in the vehicle 1 during autonomous driving, and be removed from the holding section by the user during manual driving to input control operations.

Alternatively, the operation device 60 may be of a vehicle-fixed type configured to accept control operations while being fixed to the vehicle 1. The vehicle-fixed type operation device 60 may be an in-vehicle device sensor configured to detect at least one type of user instruction state for in-vehicle equipment, such as the operating state of an on/off switch, the operating state of a touch panel, and a non-contact recognizable gesture. It should be noted that, unlike a conventional steering member, the vehicle-fixed type operation device 60 electrically transmits steering operations to the electric power steering device without transmitting any physical rotational movement to the electric power steering device. It should be noted that the operation device 60 may include an operation device configured to accept steering operation from inside the vehicle and an operation device configured to accept steering operation from outside the vehicle.

The auditory presentation system 70 provides notification information to the user of the vehicle 1 by delivering sound information that stimulates the user's sense of hearing. The auditory presentation system 70 may be at least one type selected from devices such as speakers, buzzers, and vibration units.

The display system 80 provides notification information to the user of the vehicle 1 by presenting visual information that stimulates the user's sense of sight. The display system 80 may include an in-vehicle display device 81 for displaying information inside the vehicle cabin, and an external display device 82 for displaying information outside the vehicle.

The in-vehicle display device 81 includes a display device configured to display at least one type of information selected from vehicle information related to the vehicle 1 and entertainment information. The in-vehicle display device 81 may include a meter display (hereinafter, MD) 81a configured to display at least one type of vehicle information, such as speed information and the rotational speed of the drive source. The in-vehicle display device 81 may include a center information display (hereinafter, CID) 81b configured to display entertainment information and disposed in the central area in the vehicle width direction in the vehicle. The entertainment information refers to information other than information related to the status of the vehicle 1. For example, entertainment information is video content unrelated to the status of the vehicle 1, such as movies, television programs, and internet-streamed videos. The display system 80 may include at least one type selected from among a HUD (Head-Up Display), an MFD (Multi-Function Display) provided in an area other than the central region in the vehicle width direction, and a light-emitting unit.

The external display device 82 may be a display provided on an outer part of the vehicle 1, particularly on or near the door. The external display device 82 may also be a display provided at the front or rear of the vehicle 1. The external display device 82 may be provided at multiple locations.

The control device 100 is connected to the sensor system 10, the communication system 20, and the map database 30 via at least one type of connection selected from among a LAN (Local Area Network) line, a wire harness, an internal bus, and a wireless communication line. In addition, the control device 100 is connected to the drive/brake system 40, the operation device 60, the auditory presentation system 70, and the display system 80 via at least one type of connection selected from among a LAN line, wire harness, internal bus, and wireless communication line. The control device 100 includes at least one dedicated computer.

The dedicated computer constituting the control device 100 may be an HCU (HMI (Human Machine Interface) Control Unit) that controls information presentation by information presentation systems such as the auditory presentation system 70 and the display system 80 in the vehicle 1. The dedicated computer constituting the control device 100 may be an integrated ECU (Electronic Control Unit) that integrates the driving control of the vehicle 1. The dedicated computer constituting the control device 100 may be a determination ECU that determines the driving tasks in the driving control of the vehicle 1. The dedicated computer constituting the control device 100 may be a monitoring ECU that monitors the driving control of the vehicle 1. The dedicated computer constituting the control device 100 may be an evaluation ECU that evaluates the driving control of the vehicle 1.

The dedicated computer constituting the control device 100 may be a steering control ECU specialized in the control of the steering system 50. The dedicated computer constituting the control device 100 may be a navigation ECU that navigates the travel route of the vehicle 1. The dedicated computer constituting the control device 100 may be a locator ECU that estimates the self-state quantities of the vehicle 1. The dedicated computer constituting the control device 100 may be an actuator ECU that controls the driving actuators of the vehicle 1. The dedicated computer constituting the control device 100 may be a computer other than the vehicle 1, such as an external center or mobile terminal capable of communicating with the vehicle 1.

The dedicated computer constituting the control device 100 includes at least one memory 101 and at least one processor 102. The memory 101 is at least one type of non-transitory tangible storage medium, which non-transitorily stores computer-readable programs and data. Examples of the non-transitory tangible storage medium include semiconductor medium, magnetic medium, and optical medium. Here, “storage” may refer to accumulation in which data is retained even when the vehicle 1 is powered off, or it may refer to temporary storage in which data is erased when the vehicle 1 is powered off. The processor 102 includes at least one type of core, such as a CPU (Central Processing Unit), GPU (Graphics Processing Unit), RISC-CPU (Reduced Instruction Set Computer CPU), CISC-CPU (Complex Instruction Set Computer CPU), DFP (Data Flow Processor), or GSP (Graph Streaming Processor).

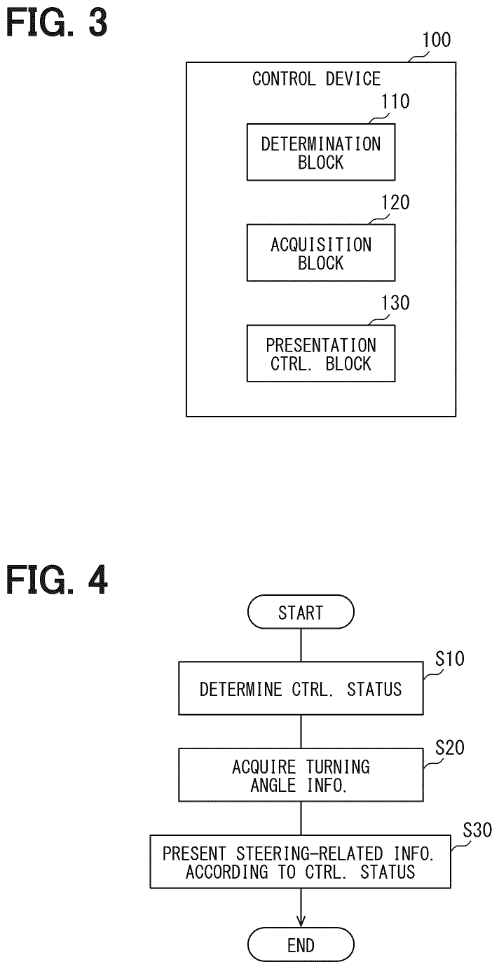

In the control device 100, the processor 102 executes multiple instructions included in a control program stored in the memory 101 as a storage medium, in order to control information presentation in the vehicle 1. As a result, the control device 100 constructs multiple functional blocks for controlling information presentation in the vehicle 1. The functional blocks constructed in the control device 100 include, as shown in FIG. 3, a determination block 110, an acquisition block 120, and a presentation control block 130.

Through the cooperation of these blocks 110, 120, and 130, the control method by which the control device 100 controls display on the display system 80 is executed according to the control flow shown in FIG. 4. The control flow shown in FIG. 4 is repeatedly executed while the vehicle 1 is in operation. It should be noted that each “S” in the control flow represents a respective step that is executed by a plurality of instructions included in the control program.

First, in S10, the determination block 110 executes determination of the current control status of the vehicle 1. The determination block 110 broadly classifies the control status, for example, into a normal autonomous driving scene, a stop scene, and an emergency stop scene. The normal autonomous driving scene is a scene in which normal driving control is being executed by autonomous driving. The stop scene is a scene in which stop control to a stopping area by autonomous driving is initiated. Here, the stopping area refers to an area where the user is expected to board or get off from the vehicle 1 that has stopped. The stopping area includes at least one type of area such as a boarding zone prepared for users who use the service to get on and off the vehicle 1, a parking lot for parking the vehicle 1, an area around the user waiting to board or get off the vehicle 1, or simply an area set as the destination for autonomous driving.

The determination block 110 may determine that the stop control has been started, for example, when a travel trajectory to the stopping area, as an end position, in a short-term control plan for autonomous driving has been generated, or when vehicle control according to the generated travel trajectory to the stopping area has been started. Alternatively, the determination block 110 may determine that the stop control has been started when the approach of the vehicle 1 within a predetermined distance range to the stopping area is detected.

In addition, in the stop scene, the determination block 110 further determines more detailed control conditions. Specifically, the determination block 110 determines expected manner of turning behavior (turning mode) of the tires 54 that is expected until the vehicle stops. The turning behaivior may include at least one of the cumulative amount of change in the turning angle (i.e., the turning amount) and the number of times the turning direction is switched, from the start to the completion of the stop control. The start point of the stop control may be the point in time when a travel trajectory to the stopping point is generated in a short-term control plan for autonomous driving, or the point in time when vehicle control according to the generated travel trajectory is initiated. Alternatively, the start point of the stop control may be the point in time when the approach of the vehicle 1 within a predetermined distance range to the stopping point is detected. The completion point of the stop control is the end of the travel trajectory, that is, the point in time when the vehicle reaches the stopping point, and the travel speed becomes substantially zero.

The emergency stop scene is a situation in which emergency stop control is executed by autonomous driving. The determination block 110 determines that it is an emergency stop scene when stop control by MRM (Minimum Risk Maneuver) control is performed. The MRM control is executed by the autonomous driving ECU when an incident that makes safe driving impossible occurs.

Alternatively, the determination block 110 may determine that it is an emergency stop scene when an emergency stop initiation operation is performed by the onboard user. For example, in a situation where an emergency vehicle is approaching and emergency evacuation is not executed in autonomous driving mode, the user may determine that emergency evacuation is necessary and perform an emergency stop initiation operation. The emergency stop initiation operation may be received by the determination block 110, for example, via an in-vehicle device sensor.

In addition, the determination block 110 further determines more detailed control conditions in the emergency stop scene. Specifically, as control conditions, the determination block 110 determines at least one of whether the vehicle 1 is operated by the user via the operation device 60 after the emergency stop, the location of the user's operation, and the degree of restriction on the operation. Determination of the location of the user's operation includes at least determining whether the operation is performed inside or outside the vehicle cabin. Determination of the degree of restriction on operation includes at least determining at least one of whether there is an abnormality in the sensor system 10, whether there is a restriction on a driving allowable direction, and the extend of the restriction on the driving allowable direction if there is a restriction on the driving allowable direction.

Subsequently, in step S20, the acquisition block 120 acquires turning angle information regarding the turning angles of the tires 54 under automatic turning control in the vehicle 1 during autonomous driving. The turning angle information includes at least one of the current actual turning angle and the target turning angle after a predetermined control cycle.

Then, in step S30, the presentation control block 130 presents steering-related information associated with virtual steering control. The presentation control block 130 presents the steering-related information in a presentation mode corresponding to the control status determined in step S10. Here, the presentation mode includes the type of information to be presented and whether or not the information is presented. In particular, when displaying an object as part of information presentation, the presentation mode (i.e., the display mode) includes the type of shape of the display object, the type of information represented by the display object, and whether or not the display object is shown.

Hereinafter, the presentation modes of the steering-related information for each scene in step S30 will be explained in detail.

### Normal Autonomous Driving Scene

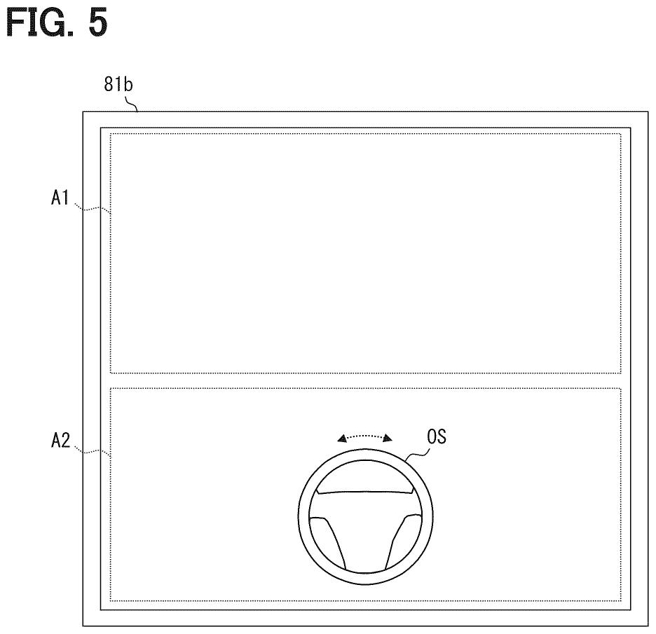

In a normal autonomous driving scene, the presentation control block 130 causes the display system 80, which displays at least one of the vehicle's speed information and entertainment information, to display a steering-related image as the steering-related information. As one example, the presentation control block 130 causes the CID 81b to display the steering-related image. For example, as shown in FIG. 5, the presentation control block 130 causes the CID 81b to display the steering-related image in a display area A2, which is separate from a display area A1 that is for displaying entertainment information on the CID 81b. The steering-related image includes at least a steering object OS shown in FIG. 5.

The steering object OS is a display element indicating a virtual steering member. For example, the steering object OS has a substantially circular shape resembling a steering wheel. The steering object OS is displayed so that its rotation (i.e., the change in rotation angle) matches the amount of turning during autonomous driving. Specifically, the presentation control block 130 sets a rotation change rate, which is a rate of change in the rotation amount of the steering object OS with respect to the amount of turning, and displays the steering object OS as rotating at the set rotation change rate. In other words, the presentation control block 130 performs the rotational display of the steering object OS at a rotation amount obtained by multiplying the turning amount by a predetermined coefficient.

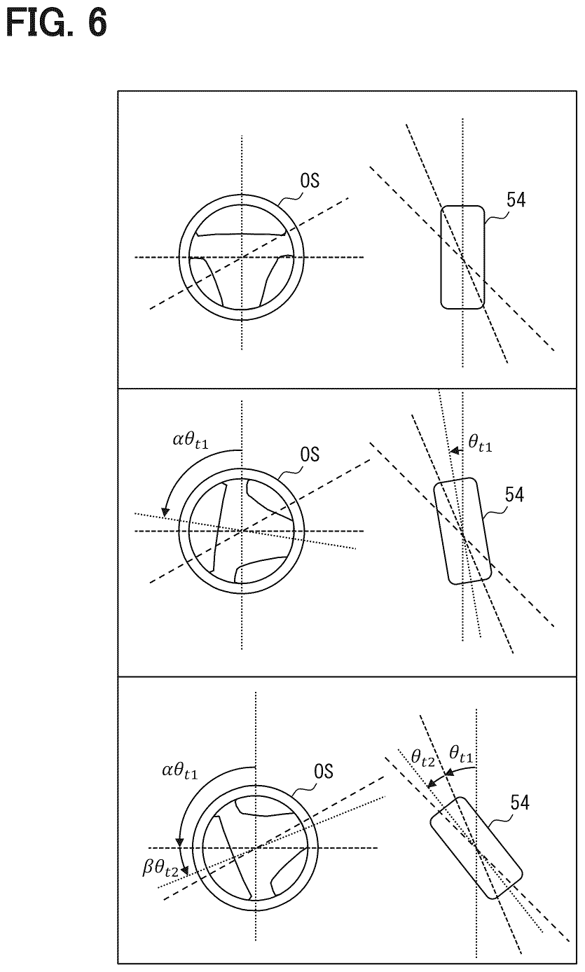

The presentation control block 130 changes the rotation change rate depending on whether the magnitude of the rotation angle from a reference angle (for example, zero degrees) is within the allowable rotation angle range or outside the allowable rotation angle range. Here, the allowable rotation angle range refers to the range between the lower threshold value, inclusive or exclusive, and the upper threshold value, inclusive or exclusive. The presentation control block 130 suppresses the rotation change rate when the rotation angle falls outside the allowable rotation angle range, compared to when it is within the allowable rotation angle range. In other words, when the ration angle falls outside the allowable rotation angle range, the presentation control block 130 performs rotational display of the steering object OS by multiplying the turning amount by a coefficient smaller than that used when the rotation angle is within the allowable rotation angle range. In the example shown in FIG. 6, the maximum rotation angle of the steering object OS corresponding to the maximum turning angle is set to ±120 degrees. Within the ranges of +90 degrees to +120 degrees and −120 degrees to −90 degrees, a coefficient smaller than that within the ±90 degree range is set. As a result, the rotation change rate is smaller than that within the ±90 degree range.

In addition, in the normal autonomous driving scene, the presentation control block 130 audibly presents, as the steering-related information, sound information corresponding to the rotation of the steering object OS. For example, the auditory presentation system 70 presents a pseudo sound in the vehicle that imitates the sound generated by the tires 54 rubbing against the road surface during steering while the steering object OS is rotating. The presentation control block 130 may change the manner of presenting sound information according to the rotational speed of the steering object OS. For example, the presentation control block 130 may present sound information with a greater volume as the rotational speed of the steering object OS increases. Alternatively, the presentation control block 130 may present sound information with a higher pitch as the rotational speed increases. Alternatively, the presentation control block 130 may present sound information with varying intonation according to the rotational speed. Alternatively, the presentation control block 130 may present periodic sound information with varying frequencies according to the rotational speed.

In addition, in the normal autonomous driving scene, when it is estimated that the user on board has no experience in manually operating a vehicle, the presentation control block 130 prevents the display of the steering object OS. The presentation control block 130 estimates whether the user boarding the vehicle 1 has experience in operating a vehicle, for example, through personal authentication of the user. Specifically, the presentation control block 130 may estimate that the user has no vehicle driving experience when the user's age, obtained through personal authentication, is below the legal age for obtaining a driver's license, and may estimate that the user has driving experience when the user has reached the eligible age.

When both a user estimated to have no vehicle driving experience and a user estimated to have driving experience are on board, the presentation control block 130 executes the display of the steering object OS. In other words, the presentation control block 130 prevents the display of the steering object OS only when it is estimated that only users with no vehicle driving experience are on board.

### Stop Scene

In the stop scene, when an expected turning behavior until the vehicle stops is within the allowable range, the presentation control block 130 displays the steering object OS as the steering-related image, in the same manner as in the aforementioned normal autonomous driving scene. On the other hand, when the expected turning behavior until the vehicle stops is an unacceptable behavior, the presentation control block 130 prevents the display of the steering object OS.

For example, the presentation control block 130 may determine that the expected turning behavior is allowable when the expected cumulative turning amount is equal to or below the allowable upper limit, and may determine that the expected turning behavior is unacceptable when the expected cumulative turning amount exceeds the allowable upper limit. Alternatively, the presentation control block 130 may determine that the expected turning behavior is allowable when the expected number of changes in the turning direction is equal to or below the allowable upper limit, and may determine that the expected turning behavior is unacceptable when the expected number of changes exceeds the allowable upper limit.

### Emergency Stop Scene

After the emergency stop of the vehicle 1 is completed in the emergency stop scene, the presentation control block 130 displays the steering object OS and an association object OL as steering-related images. Furthermore, the presentation control block 130 of the present embodiment displays, in addition to the steering object OS and the association object OL, the front/rear object OFR as the steering-related images.

When receiving a rotation operation of the vehicle 1 from the vehicle cabin, the presentation control block 130 causes the in-vehicle display device 81 to display the above-mentioned steering-related images. The in-vehicle display device 81 displays at least one of speed information and entertainment information. On the other hand, when receiving a rotation operation of the vehicle 1 from outside the vehicle 1, the presentation control block 130 causes the external display device 82 to display the steering-related images. It should be noted that when the presentation control block 130 receives a user's rotation operation via the operation device 60 after an emergency stop, the presentation control block 130 displays the steering-related images regardless of the turning mode. Furthermore, the external display device 82 that shows the steering-related images does not necessarily have to display at least one of speed information or entertainment information. Furthermore, unless otherwise specified, the following descriptions of each steering-related image apply equally to cases where they are displayed on the in-vehicle display device 81 and on the external display device 82.

When displaying the steering object OS, the presentation control block 130 receives turning operations for the vehicle 1 by the user via the operation device 60, through which the user's control inputs are entered. The presentation control block 130 rotates the steering object OS in response to the user's steering operation. In other words, the presentation control block 130 displays the steering object OS with a rotation amount that correlates with the turning angle corresponding to the user's steering operation.

The front/rear object OFR is a display object that indicates the forward or reverse movement of the vehicle 1 in response to the operation of the operation device 60. For example, the front/rear object OFR includes a forward object OF that is displayed when the vehicle 1 is moving forward, a reverse object OR that is displayed when the vehicle 1 is moving backward, and a vehicle object OC, which is an icon representing the vehicle 1.

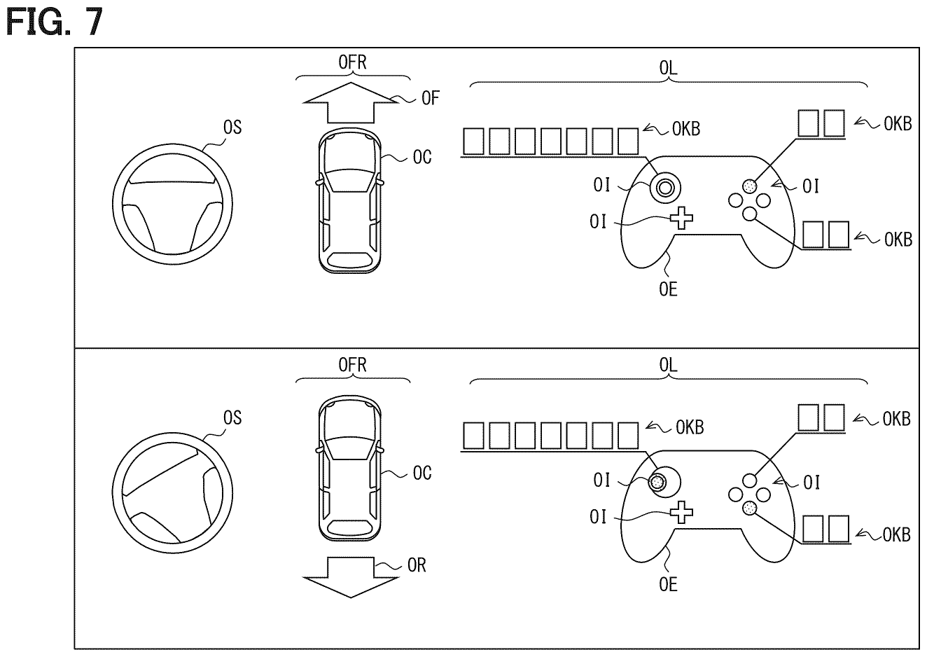

The association object OL is a display object that indicates the relationship between the operation of the operation device 60 and the rotational display of the steering object OS. For example, as shown in FIG. 7, the association object OL includes an appearance object OE, an input object OI, and a key bind object OKB. The appearance object OE is an object shaped to resemble the operation device 60, and in FIG. 7, the appearance object OE presents a control pad shape. The input object OI is an object shaped to resemble an input component of the operation device 60 where operations are entered. In the example of FIG. 7, icons shaped to resemble buttons, a joystick, and a directional pad are displayed as the input object OI. The key bind object OKB is an object that indicates the correspondence between the input components and the control contents. In the example of FIG. 7, a line extending from the input object OI and a text section shown as a series of rectangles are displayed as the key bind object OKB. The line in the key bind object OKB indicates the corresponding input component. The text section in the key bind object OKB indicates the control content that can be executed by operating the corresponding input component, through character information. As an example, for the input object OI corresponding to the button that enables forward movement when pressed, the key bind object OKB that includes a line extending from the input object OI and a text section above the line labeled “Forward” is displayed. Similarly, for the input object OI corresponding to the button that enables backward movement when pressed, the key bind object OKB that includes a line extending from the input object OI and a text section above the line labeled “Backward” is displayed. Additionally, for the input object OI corresponding to the joystick that allows rotation of the steering wheel 51 when tilted left or right, the key bind object OKB that includes a line extending from the input object OI and a text section above the line labeled “Steering wheel rotation with left/right” is displayed.

When steering by the user via the operation device 60 is possible, the presentation control block 130 first displays the steering object OS, the front/rear object OFR, and the association object OL. Then, when an operation is performed on the operation device 60, the presentation control block 130 highlights the input object OI corresponding to the operated input component. Furthermore, the presentation control block 130 executes rotational display of the steering object OS in accordance with the operation, and forward/backward display by the front/rear object OFR.

For example, as shown in the upper frame of FIG. 7, when no operation corresponding to steering is input and an operation corresponding to forward movement is input, the presentation control block 130 highlights the input object OI corresponding to forward movement by, for example, changing the brightness or display color of the input object OI. Then, the presentation control block 130 keeps the steering object OS in its initial angle state, displays the forward object OF and the vehicle object OC in the front/rear object OFR, and hides the reverse object OR. Also, as shown in the lower frame of FIG. 7, when a steering operation to the left and an operation corresponding to reverse are input, the presentation control block 130 highlights both the input object OI corresponding to reverse and the input object OI corresponding to left steering. Then, the presentation control block 130 rotationally displays the steering object OS to the left, displays the reverse object OR and the vehicle object OC in the front/rear object OFR, and hides the forward object OF.

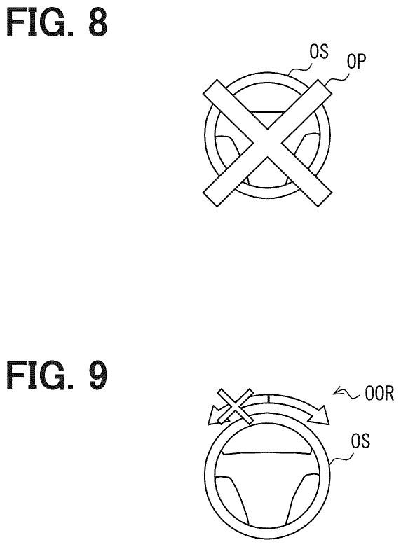

When an abnormality is detected in the sensor system 10 related to the driving control of the vehicle 1, the presentation control block 130 prevents receiving operations from outside the vehicle 1. Upon detection of an abnormality, the presentation control block 130 may display a prevention object OP, indicating that operation from outside the vehicle 1 via the operation device 60 is prevented, on the external display device 82. For example, as shown in FIG. 8, the presentation control block 130 displays the prevention object OP having a prevention symbol.

Further, when the driving allowable direction of the vehicle 1 is limited, the presentation control block 130 displays the operable range of the steering object OS correlated with the driving allowable direction. For example, the driving allowable direction may be limited when a stack of the vehicle 1 is detected or when a malfunction or other abnormality is detected in a sensor. For example, as shown in FIG. 9, the presentation control block 130 presents an operable range object OOR, which indicates the rotatable direction and the rotation-prevented direction of the steering object OS.

The presentation control block 130 may display the steering object OS, the association object OL, and the front/rear object OFR after the user starts the emergency stop of the vehicle 1 in the emergency stop scene. In this case, the presentation control block 130 starts accepting control operations via the operation device 60 after the user starts the emergency stop, and displays each steering-related image in accordance with the control operation.

In step S30, the presentation control block 130 presents the steering-related information in each presentation mode according to the control state of each of the above scenes. Once the presentation is executed, this flow ends. By repeatedly executing the series of processes S10, S20, and S30, the steering-related information is continuously presented while the vehicle 1 is operating, with the presentation mode being appropriately changed according to the control states.

According to the first embodiment described above, the steering-related image that at least includes the steering object OS, which is an object representing a virtual steering member is displayed. The steering object OS is rotationally displayed at a rotation angle correlated with the turning angle during autonomous driving. The steering-related image is displayed on the display system 80, which presents at least one of vehicle speed information or entertainment information, in a display mode corresponding to the control states of the vehicle 1. As a result, the user can visually check the display showing at least one of the speed information and entertainment information of the vehicle 1, and thereby grasp the traveling direction of the vehicle 1 from the steering object OS, which is presented in a display mode corresponding to the control states of the vehicle 1. Thus, convenience can be improved. In particular, in the first embodiment, the steering-related image is displayed on the CID 81b, which is a display provided in the central region in the vehicle width direction within the vehicle cabin. Thus, the steering-related image can be viewed easily for users seated in any seat.

### Second Embodiment

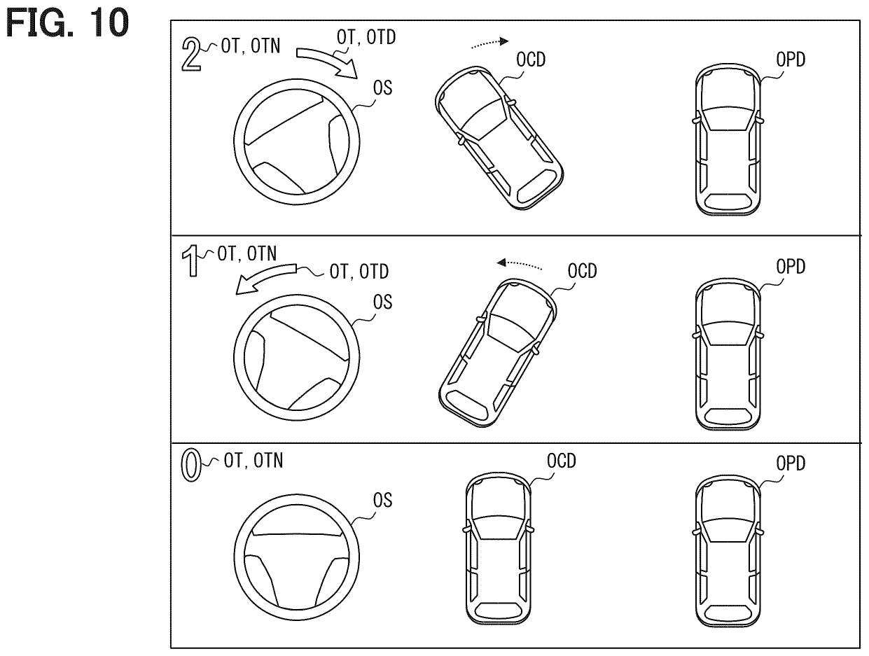

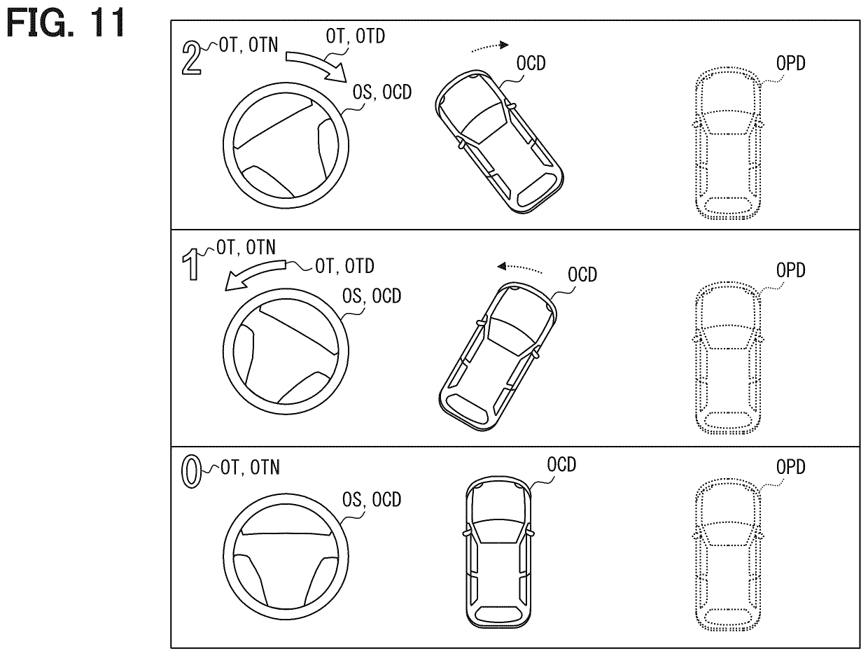

As shown in FIGS. 10 and 11, the second embodiment is a modification of the first embodiment.

In the second embodiment, in the stop scene, when the expected turning behavior that is expected until the vehicle 1 stops is allowable, the presentation control block 130 displays the steering object OS and a current heading object OCD, which indicates the current heading direction of the vehicle 1, as shown in FIG. 11. On the other hand, when the expected turning behavior is unacceptable, the presentation control block 130 displays the steering object OS, the current heading object OCD, and a predicted heading object OPD, which indicates a predicted heading direction of the vehicle 1 when the vehicle 1 stops. Furthermore, when the expected turning behavior is unacceptable, the presentation control block 130 displays a direction change object OT.

The current heading object OCD is an object that indicates the current heading direction of the vehicle 1. Here, the heading direction of the vehicle 1 refers to the yaw direction of the vehicle 1 according to the turning angle, that is, the magnitude of the yaw angle. For example, the current heading object OCD presents the magnitude of the deviation of the current heading direction relative to a reference orientation in correlation with the magnitude of the turning angle. The reference direction may be a turning angle of zero degrees (i.e., a yaw angle of zero degrees).

The current heading object OCD may be an icon shaped to resemble the vehicle 1 as viewed from above, as shown in FIGS. 10 and 11. The current heading object OCD is displayed tilted relative to the reference direction by an amount corresponding to the turning angle. Accordingly, the current heading object OCD can be described as an object that rotates in conjunction with the rotation of the steering object OS. Furthermore, since the current heading object OCD moves in accordance with the turning angle, the steering object OS may also be interpreted as an object included within the current heading object OCD.

The predicted heading object OPD is an object relating to the predicted heading direction of the vehicle 1 when the vehicle 1 stops. That is, the predicted heading object OPD displays the predicted yaw direction of the vehicle 1 corresponding to the predicted turning when the vehicle 1 stops. The predicted heading object OPD may be represented by an icon shaped to resemble the vehicle 1 as viewed from above, as shown in FIG. 10. Unlike the steering object OS and the current heading object OCD, the predicted heading object OPD is not displayed, that is, the display of the predicted heading object OPD is prevented, when the expected turning behavior is allowable, as shown in FIG. 11.

The direction change object OT is an object relating to at least one of the expected number of changes in the direction until the vehicle 1 stops, or the rotation direction for each change in the direction of the steering object OS. For example, as shown in FIG. 10, the direction change object OT includes both a count object OTN, which displays the expected number of direction changes, and a direction object OTD, which displays the rotation direction for each direction change.

The count object OTN may be displayed as a numeric-shaped icon, presenting the number of direction changes using numerical information. Here, the number of direction changes refers to the number of times the rotation direction of the steering object OS is reversed. When the stop control starts, the count object OTN displays the total number of expected direction changes from the start to the completion of the stop control. The number displayed by the count object OTN decreases each time a direction change is performed. That is, the count object OTN presents a countdown of the remaining number of direction changes at the current moment.

The direction object OTD may be displayed as an arrow-shaped icon, and indicates the direction of the change. For each direction change, the direction object OTD presents the rotation direction of the steering object OS using an arrow. For example, the direction object OTD displays the reversed direction in advance of the reversal of the rotation direction of the steering object OS. In other words, the direction object OTD provides advance notification of the upcoming direction change.

### Third Embodiment

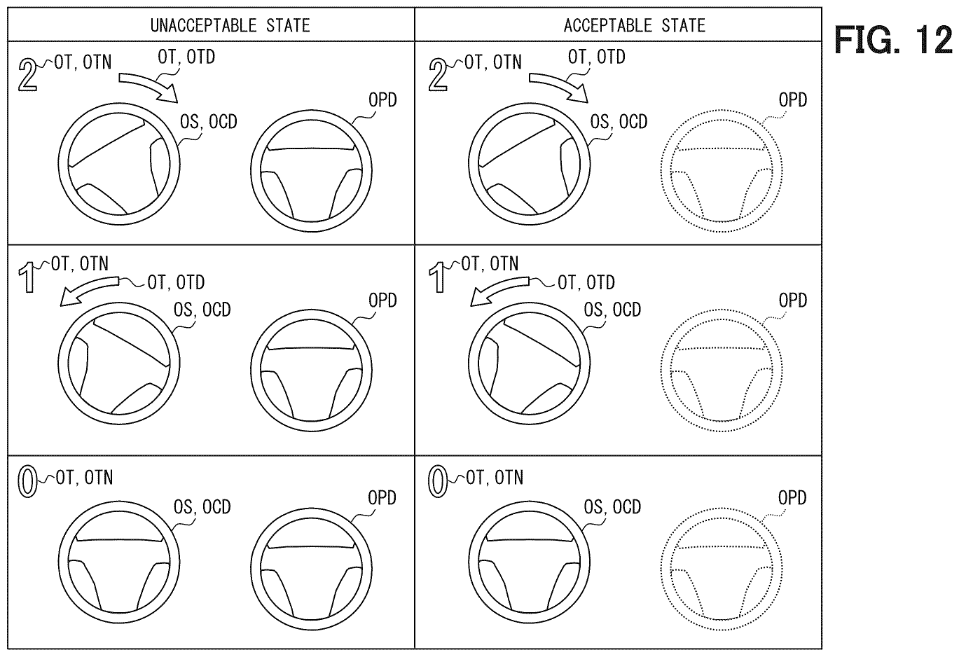

As shown in FIG. 12, the third embodiment is a modification of the second embodiment.

In a stop scene, when the expected turning behavior is unacceptable, the presentation control block 130 displays the steering object OS and the predicted heading object OPD. The presentation control block 130 does not display the current heading object OCD, which is a separate object from the steering object OS, as in the second embodiment. Since the steering object OS can be interpreted as an object included in the current heading object OCD, the presentation control block 130 can achieve the display of the current direction of the vehicle 1 by displaying only the rotation of the steering object OS.

Further, when the expected turning behavior is unacceptable, the presentation control block 130 displays the predicted heading object OPD as an icon shaped to resemble a steering member having substantially the same shape as the steering object OS, as shown in the left column of FIG. 12. The predicted heading object OPD is fixedly displayed to represent an expected rotation angle corresponding to the expected turning angle when the vehicle 1 stops, without rotating in response to changes in the turning angle. For example, in the case shown in FIG. 12, the predicted heading object OPD is displayed at a rotation angle corresponding to the turning angle of zero degrees (that is, at zero degrees). When the expected turning behavior is allowable, the presentation control block 130 hides the predicted heading object OPD, as shown in the right column of FIG. 12.

### Fourth Embodiment

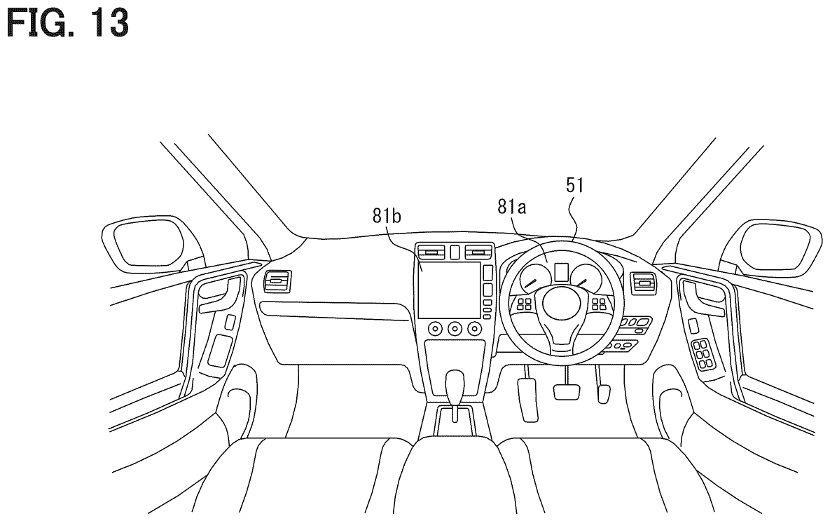

As shown in FIGS. 13 to 15, a fourth embodiment is a modified example of the first embodiment.

In the fourth embodiment, the steering system 50 of the vehicle 1 includes a steering wheel 51 in addition to the configuration of the first embodiment, as shown in FIG. 13. The steering wheel 51 is a steering member that physically transmits rotation operations by the user to the electric power steering device via the steering shaft. The steering wheel 51 is pre-adjusted such that its reference angular position, which is the non-rotated state (i.e., a steering angle of zero degrees), corresponds to the straight-ahead direction of the vehicle 1. In other words, the correspondence between the steering angle of the steering wheel 51 and the turning angle of the tires 54 is adjusted so that the steering angle of the steering wheel 51 is substantially zero degrees when the turning angle of the tires 54 is substantially zero degrees. It should be noted that the correspondence between the steering angle and the turning angle may deviate from the original state, which is a state just after the correspondence is adjusted, due to factors such as aging or wear. The correspondence between the steering angle and the turning angle may be readjusted at the factory, for example, during battery replacement or similar maintenance.

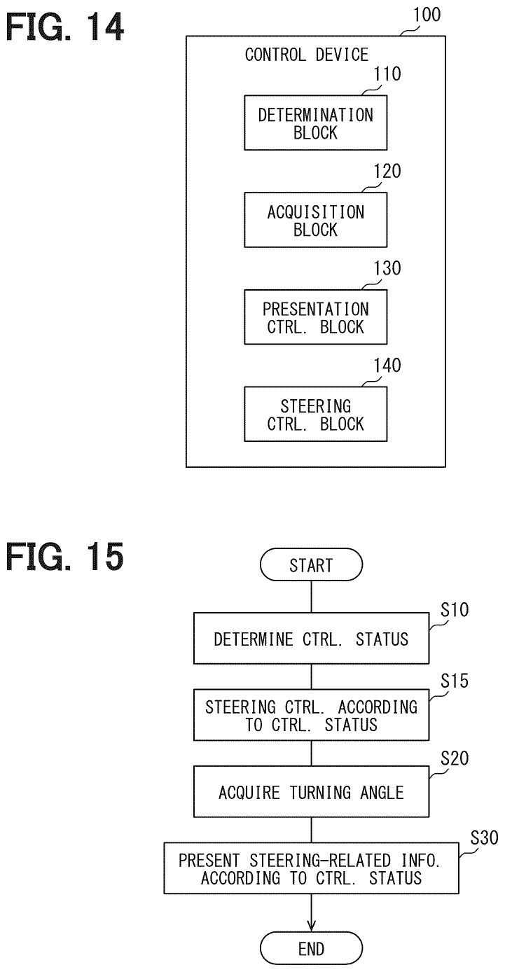

As shown in FIG. 14, the functional blocks configured in the control device 100 of the fourth embodiment include a steering control block 140, in addition to the blocks 110, 120, and 130 that are the same as those in the first embodiment. Through the cooperation of these blocks 110, 120, 130, and 140, the method by which the control device 100 controls display on the display system 80 is executed according to the control flow shown in FIG. 15.

As shown in FIG. 15, the flow proceeds to S15 after the processing of S10. In S15, the steering control block 140 executes steering control according to the control states of the vehicle 1. Specifically, when the expected turning behavior in the stop scene is allowable, the steering control block 140 controls the rotation of the steering wheel 51 in coordination with the turning control of the tires 54. On the other hand, when the expected turning behavior is unacceptable in the stop scene, the steering control block 140 disconnects the linkage between the turning control of the tires 54 and the rotational control of the steering wheel 51. For example, in the disconnected state, the steering control block 140 keeps the steering wheel 51 stationary at the steering angle of substantially zero.

Further, in S30 of the fourth embodiment, the presentation control block 130 displays the steering object OS even when the expected turning behavior is unacceptable in the stop scene. The presentation control block 130 may display at least one of the current heading object OCD, the predicted heading object OPD, and the direction change object OT. That is, when the expected turning behavior is unacceptable in the stop scene, the steering wheel 51 remains stationary, and instead, the user grasps the traveling direction of the vehicle 1 through the steering object OS.

### Other Embodiments

As described above, several embodiments have been explained, but the present disclosure is not to be construed as being limited to these embodiments, and can be applied to various embodiments and combinations thereof without departing from the spirit of the disclosure.

In a modification, the control device 100 may display a steering-related image including the steering object OS during calibration of the vehicle 1 at a factory.

In a modification, the control device 100 may control the rotational display of the steering object OS so that the rotation change rate of the steering object OS with respect to the turning amount is set to a value lower than the rotation change rate of the steering wheel 51 during manual driving with respect to the turning amount.

In a modification, the dedicated computer constituting the control device 100 may include at least one of a digital circuit and an analog circuit as a processor. Here, the digital circuit refers to at least one type among, for example, an ASIC (Application Specific Integrated Circuit), FPGA (Field Programmable Gate Array), SoC (System on a Chip), PGA (Programmable Gate Array), and CPLD (Complex Programmable Logic Device). The digital circuit may include a memory storing a program.

In a modification, the host mobile body to which the control device 100 is applied may be an autonomous mobile robot capable of carrying cargo or collecting information through autonomous or remote operation, and also configured to allow manual operation via a steering member. In addition to the above-described embodiments and modifications, the present embodiments may be implemented in forms of a control device mountable on a host moving object and including at least one processor 102 and at least one memory 101, a processing circuit (for example, a processing ECU, etc.) or a semiconductor device (e.g., semiconductor chip, etc.)

1. A control device configured to control an information presentation in a vehicle that is configured to perform autonomous driving, the control device comprising:
a processor configured to:
acquire turning angle information related to a turning angle of a tire of the vehicle under a turning control of the tire during the autonomous driving; and
present steering-related information related to a virtual steering control that corresponds to the turning control of the tire, wherein
the steering-related information includes a steering-related image including a steering object that is an object of a virtual steering member,
the processor is configured to:
present the steering-related information by displaying the steering object to rotate at a rotation angle corresponding to the turning angle during the autonomous driving on a display system, the display system being configured to display at least one of speed information of the vehicle or entertainment information; and
change a display mode of the steering-related image including the steering object according to a control state of the vehicle.

2. The control device according to claim 1, wherein
the processor is configured to determine an expected turning behavior of the tire until the vehicle stops by a stop control of the autonomous driving where the vehicle is autonomously stopped, and
the processor is configured to, during the stop control:
display the steering object based on the expected turning behavior being acceptable; and
prevent displaying of the steering object based on the expected turning behavior being unacceptable.

3. The control device according to claim 1, wherein
the steering-related image further includes:
a current heading object related to a current heading of the vehicle; and
a predicted heading object related to a predicted heading of the vehicle when the vehicle stops,
the processor is configured to determine an expected turning behavior of the tire until the vehicle stops by a stop control of the autonomous driving where the vehicle is autonomously stopped, and
the processor is configured to, during the stop control:
display the current heading object and the predicted heading object based on the expected turning behavior being unacceptable; and
display the current heading object but not the predicted heading object based on the expected turning behavior being acceptable.

4. The control device according to claim 1, wherein
the processor is further configured to prevent displaying of the steering object based on a user on the vehicle having no experience for manual driving of the vehicle.

5. The control device according to claim 1, wherein
the processor is configured to display the steering-related image including a direction change object during a stop control of the autonomous driving where the vehicle is autonomously stopped, and
the direction change object is related to at least one of an expected number of changes in a heading of the vehicle or an expected rotation direction of the steering object for each of the changes until the vehicle stops during the stop control.

6. The control device according to claim 1, wherein
a rotation change rate is defined as an amount of change in the rotation angle of the steering object relative to an amount of change in the turning angle of the tire, and
the processor is configured to adjust the rotation change rate depending on the rotation angle, within a range up to a maximum rotation angle.

7. The control device according to claim 6, wherein
the processor is configured to reduce the rotation change rate based on the rotation angle exceeding an allowable rotation angle range.

8. The control device according to claim 1, wherein
the steering-related information further includes sound information, and
the processor is configured to aurally present the sound information according to a rotation of the steering object.

9. The control device according to claim 1, wherein
the processor is configured to allow a user to perform a rotation operation of the steering object in an emergency stop scene where the vehicle is emergently stopped, and
the processor is configured to display the steering object to rotate according to the rotation operation by the user in the emergency stop scene.

10. The control device according to claim 9, wherein
the processor is configured to:
receive the rotation operation of the steering object from the user through an operation device; and
display, in the emergency stop scene, an association object of the steering-related image that indicates a correspondence between an operation of the operation device and a display of the steering object that is rotationally displayed.

11. The control device according to claim 9, wherein
the display system is disposed at least one of an inside of the vehicle or an outside of the vehicle,
the processor is configured to:
receive the rotation operation from the inside or the outside of the vehicle;
display the steering object on the display system disposed inside the vehicle based on the rotation operation being received from the inside of the vehicle; and
display the steering object on the display system outside the vehicle based on the rotation operation being received from the outside of the vehicle.

12. The control device according to claim 11, wherein
the processor is configured to prevent receiving of the rotation operation upon detecting a malfunction in a sensor relating to a driving control of the vehicle.

13. The control device according to claim 9, wherein
the processor is configured to, when a driving allowable direction of the vehicle is limited, display an operable range of the steering that is correlated to the driving allowable direction of the vehicle.

14. The control device according to claim 9, wherein
the processor is configured to allow receiving of the rotation operation from the user upon receiving an emergency stop operation of the vehicle from the user.

15. A control method executed by a processor to control an information presentation in a vehicle that is configured to perform an autonomous driving, the control method comprising:
acquiring turning angle information related to a turning angle of a tire of the vehicle under a turning control of the tire during the autonomous driving; and
presenting steering-related information related to a virtual steering control that corresponds to the turning control of the tire, wherein
the steering-related information includes a steering-related image that includes a steering object that is an object of a virtual steering member, and
the presenting of the steering-related information includes:
displaying the steering object to rotate at a rotation angle corresponding to the turning angle during the autonomous driving on a display system, the display system being configured to display at least one of speed information of the vehicle or entertainment information; and
changing a display mode of the steering-related image including the steering object according to a control state of the vehicle.

16. A non-transitory computer readable storage medium storing instructions for controlling an information presentation in a vehicle that is configured to perform an autonomous driving, the instructions being configured to, when executed by a processor, cause the processor to:
acquire turning angle information related to a turning angle of a tire of the vehicle under a turning control of the tire during the autonomous driving; and
presenting steering-related information related to a virtual steering control that corresponds to the turning control of the tire, wherein
the steering-related information includes a steering-related image that includes a steering object that is an object of a virtual steering member, and
the processor is configured to:
present the steering-related information by displaying the steering object to rotate at a rotation angle corresponding to the turning angle during the autonomous driving on a display system, the display system being configured to display at least one of speed information of the vehicle or entertainment information; and
change a display mode of the steering-related image including the steering object according to a control state of the vehicle.

17. The control device according to claim 6, wherein
the maximum rotation angle corresponds to a maximum turning angle of the tire.
